(19) United States
(12) Patent Application Publication
(10) Pub. No.: US 2026/0067391 A1
(43) Pub. Date: Mar. 5, 2026

(54) Vehicle-mounted earphone call system

(71) Applicant: Dongguan LingGui Technology Innovation Co., Ltd.

(72) Inventor: Xia Liu, Dongguan (CN)

(21) Appl. No.: 18/894,227

(22) Filed: Sep. 24, 2024

(30) Foreign Application Priority Data
Sep. 5, 2024 (CN) 2024112389781

(51) Int. Cl. H04M 1/60; B60R 11/02; H04W 4/80

(52) U.S. Cl. CPC H04M 1/6066; B60R 11/0247; H04W 4/80

(57) ABSTRACT

A vehicle-mounted earphone call system includes a car charger and a Bluetooth earphone; an earphone position is provided on the car charger and used for placing the Bluetooth earphone; a first magnetic member and two first terminal posts are provided in the earphone position; a second magnetic member and two second terminal posts are provided in the Bluetooth earphone; when the Bluetooth earphone is placed in the earphone position, the second magnetic member and the first magnetic member attract each other, and the two second terminal posts are connected to the two first terminal posts; when the mobile phone is requested to communicate, the Bluetooth earphone is used for answering, the Bluetooth earphone is taken out from the earphone position, and the mobile phone is controlled to answer; when the Bluetooth earphone returns to the earphone position, the Bluetooth earphone controls the mobile phone to hang up.

### FIELD OF THE INVENTION

The present disclosure relates to the technical field of the earphone, particularly, to a vehicle-mounted earphone call system.

### BACKGROUND OF THE INVENTION

Vehicle-mounted earphones are using a wireless Bluetooth communication technology designed and developed based on wireless Bluetooth technology. Through specific functions, they are specifically designed to provide drivers with the services to communicate with their phones through Bluetooth technology during normal driving, achieving the goal of freeing their hands and reducing traffic hazards.

For example, The Chinese patent document with the publication number CN106331929A disclosed a Bluetooth earphone and a combination system of the Bluetooth earphone and the car cigarette lighter magnetic sensor, which included a Bluetooth antenna, a Bluetooth decoding chip, a microphone/a microphone, a magnetic sensor, a pair of earphone speakers, and several indicator lights. The combination system of Bluetooth earphones and car cigarette lighter magnetic sensor also included a car cigarette lighter and Bluetooth earphones. The car cigarette lighter had an adapter slot for placing the Bluetooth earphones, and a platform for placing the Bluetooth earphones is provided around the opening of the adapter slot. The car cigarette lighter was equipped with a magnetic block on the inner side thereof corresponding to the platform, the magnetic block absorbed the metal or magnetic parts inside the Bluetooth earphones to achieve convenient placement and alignment of the Bluetooth earphones. The Bluetooth earphones could answer or hang up calls based on the strength of the magnetic field when the Bluetooth earphones were removed from or inserted into the adapter slot.

In the technical solution of the above patent document, answering or hanging up a call is performed by detecting the strength of the magnetic field through a magnetic sensor. However, the magnetic field is easily interfered with external signals, and misjudged detection can lead to self-hanging up the call during the call process.

### SUMMARY OF THE INVENTION

The object of the present disclosure is to provide a vehicle-mounted earphone call system, so as to solve the problem in the prior art that the vehicle-mounted earphone answers or hangs up a call by means of a magnetic field detection, which is to misjudge and causes a hang-up to affect the user experience of a driver.

To achieve the above object, the present disclosure provides a vehicle-mounted earphone call system, which includes a car charger and a Bluetooth earphone. The car charger is used to connect a power outlet of a vehicle. An earphone position is provided in the car charger and used for placing the Bluetooth earphone. A first magnetic member and two first terminal posts are provided in the earphone position. A second magnetic member and two second terminal posts are provided in the Bluetooth earphone. When the Bluetooth earphone is placed in the earphone position, the second magnetic member and the first magnetic member attract each other, and the second terminal posts are connected to the corresponding first terminal posts. The Bluetooth earphone and the mobile phone are in a Bluetooth connection. When the mobile phone is requested to make a call, the Bluetooth earphone is used for answering, that is, the Bluetooth earphone is taken out from the earphone position so that the second terminal posts of the Bluetooth earphone are powered off, and at the same time, the mobile phone is controlled to answer the call. When the Bluetooth earphone returns to the earphone position, the second terminal posts are reconnected to the first terminal posts to charge the Bluetooth earphone, and the Bluetooth earphone controls the mobile phone to hang up.

Further, the Bluetooth earphone and the car charger are respectively equipped with a first sensing element and a second sensing element; when the first sensing element and the second sensing element are separated from sensing each other, and the input voltage of the second terminal posts of the Bluetooth earphone drops from 5V to 0V, the Bluetooth earphone is connected to the mobile phone and connects the incoming call; when the first sensing element and the second sensing element mutually sense each other, and the Bluetooth earphone detects the input voltage from the second terminal posts, the mobile phone automatically hangs up.

Further, the first sensing element is a Hall sensor arranged in the Bluetooth earphone, the second sensing element is a magnet arranged in the earphone position, when the Bluetooth earphone is taken out from the earphone position, the Hall sensor can not detect the magnet field.

Further, when the mobile phone is calling, the Bluetooth earphone is taken out from the earphone position, the call is switched to the Bluetooth earphone.

Further, after the vehicle is started up, the supplies power of the vehicle charges to the Bluetooth earphone by means of the car charger and actives the Bluetooth earphone to start up; when the vehicle is shut down, the supplies power of the vehicle is powered off, the input voltage of the Bluetooth earphone is zero, the Bluetooth earphone identifies the zero input Voltage, and the sensing element and the second sensing element keep mutual sense, and the Bluetooth earphone is powered off.

Further, the Bluetooth earphone is equipped with a touch switch that can only adjust the volume.

The above-mentioned one or more technical solutions in the vehicle-mounted earphone call system provided in the embodiments of the present disclosure have at least the following technical effects:

The car charger connected to the power outlet of the vehicle is disposed in the vehicle and can be used to charge the Bluetooth earphone. The car charger is provided with the earphone position for placing the Bluetooth earphone. Because the earphone position is provided with the first magnetic number and two first terminal posts, and the Bluetooth earphone is provided with the corresponding second magnetic number and two second terminal posts, it is convenient for the driver to replace the Bluetooth earphone back to the car charger for charging, the driver no need to low head to observe and accurately find the earphone position. Since the first magnetic member and the second magnetic member attract each other, the Bluetooth earphone can automatically return to the earphone position by means of the magnetic attraction, The process does not affect the observation of the external environment, thereby improving the safety of the driver when driving the vehicle, and also avoiding falling caused by unstable connection of the Bluetooth earphone when the vehicle runs. Then, the second terminal posts are connected to the first terminal posts so that the car charger charges the Bluetooth earphone.

When the vehicle runs, the Bluetooth earphone is charged in the car charger, the Bluetooth earphone is kept in a power-on state and is automatically connected to the mobile phone through Bluetooth. When the mobile phone is requested to make a call, the Bluetooth earphone is taken out, and at this time, the second terminal posts are separated from the first terminal posts, and the second terminal posts are powered off, so that the Bluetooth earphone is disconnected from the power supply of the vehicle and automatically answers the call. When the Bluetooth earphone is put back into the earphone position, the second terminal posts are connected to the first terminal posts again, and the second terminal posts receive the input voltage to recharge the Bluetooth earphone, and at this time, the Bluetooth earphone hangs up the call.

### BRIEF DESCRIPTION OF THE DRAWINGS

In order to clearly illustrate the technical schemes in the embodiments in the present disclosure, the drawings needed in the embodiments or the prior technical description are briefly introduced below. Obviously, the drawings described below are only some embodiments in the present disclosure, and for those skilled in the art, additional drawings may be obtained according to the drawings below without creative work.

FIG. 1 is a flowchart of the vehicle-mounted earphone call system according to an embodiment of the present disclosure.

FIG. 2 is a perspective view of the car charger according to an embodiment of the present disclosure.

FIG. 3 is a perspective view of the Bluetooth earphones according to an embodiment of the present disclosure.

FIG. 4 is an in-section view of the Bluetooth earphones placed on the car charger according to an embodiment of the present disclosure.

### Reference Number

Car charger 10, the earphone position 11, the first magnetic number 12, the first terminal post, the Bluetooth earphones 20, the second magnetic element 21, the second terminal post 22.

### EMBODIMENTS

Embodiments of the present invention are described in detail below, and examples of the embodiments are shown in the attached drawings, in which the same or similar labels represent the same or similar elements or elements with the same or similar function. The embodiments described below by reference to the attached drawings are exemplary and are intended to explain embodiments of the present invention and cannot be understood as limits in the present invention.

In the description of the embodiments of the present invention, it should be understood that the directional indications involved in the embodiments, such as the “length”, “width”, “upper”, “lower”, “left”, “right”, “front”, “rear”, “internal” and “external”, indicating orientation or location relationship, are based on the orientation or position relationship showed in the figures. These directional indications are only for describing the embodiments in the present invention and simplifying the description, rather than indicating or implying that the device or the element must be constructed and operated in a specified azimuth, which cannot be understood as a limitation of the present invention.

Further, the terms “first”, and “second” are used only for description purposes, and cannot be understood as indicating or implying relative importance or implicitly indicating the number of technical features indicated. Thus, features defining “first” and “second” may expressly or implicitly include one or more of the features. In the description of the embodiments of the present invention, the “plurality of” means two or more unless otherwise specifically limits.

In the embodiment of the invention, unless other specified and qualified, the terms “installation ”,“ connection ”,“ fixed” and other terms shall be broadly understood, for example, it may be fixed connection, detachable connection, or integration; it may be a mechanical connection or an electrical connection; it may be directly connected or indirectly connected by intermediate media, it may be an internal connection of two components or the interaction of two components. For ordinary technicians in the field, the specific meaning of the above term in the embodiment of the invention can be understood according to the specific circumstances.

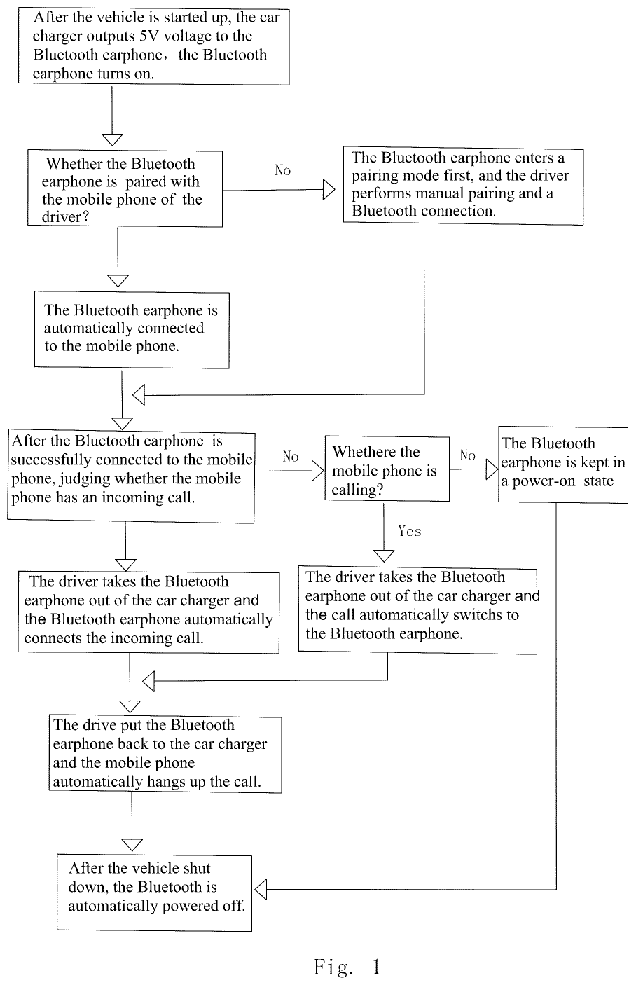

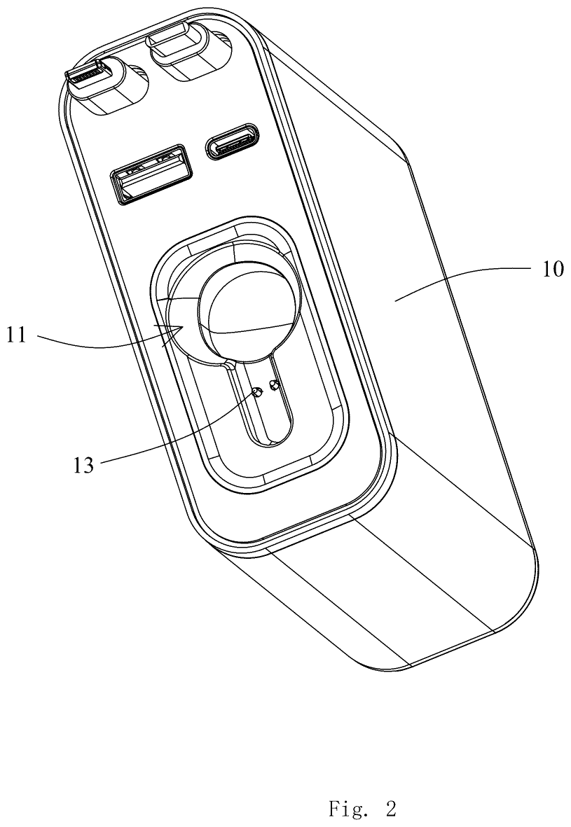

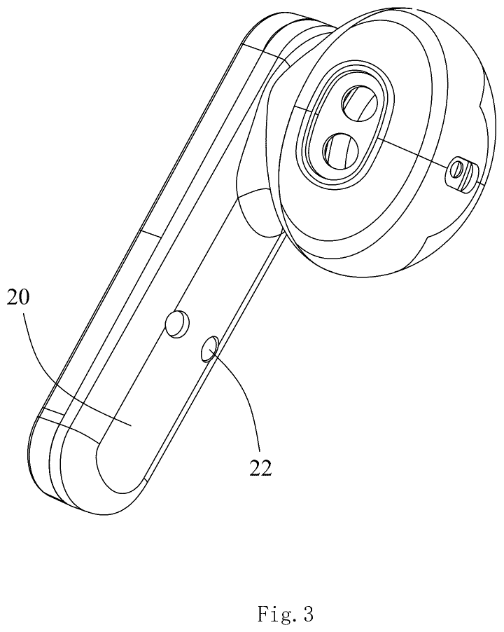

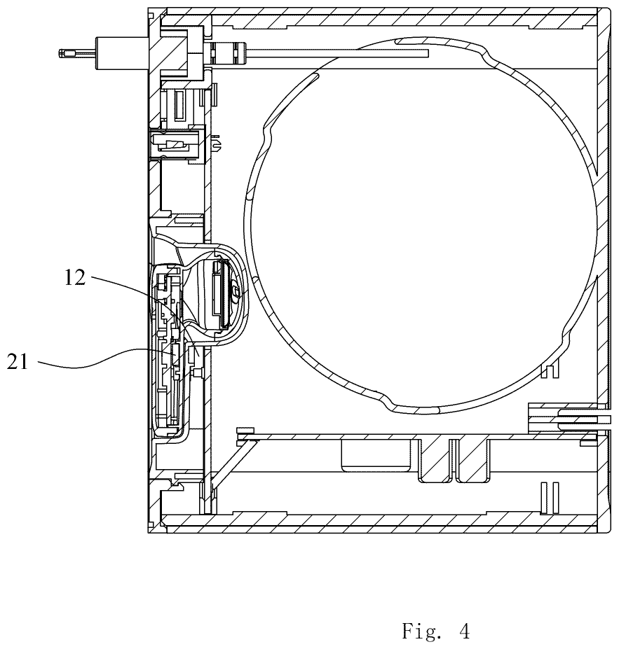

In an embodiment of the vehicle-mounted earphone call system according to the present disclosure, referring to FIGS. 1-5, the vehicle-mounted earphone call system includes a car charger 10 and a Bluetooth earphone 20. The car charger 10 is used to connect a power outlet of a vehicle. An earphone position 11 is provided on the car charger 10 and used for placing the Bluetooth earphone 20. A first magnetic member 12 and two first terminal posts 13 are provided in the earphone position 11. A second magnetic member 21 and two second terminal posts 22 are provided in the Bluetooth earphone 20. When the Bluetooth earphone 20 is placed in the earphone position 11, the second magnetic member 21 and the first magnetic member 12 attract each other, and the second terminal posts 22 are connected to the corresponding first terminal posts 13. The Bluetooth earphone 20 and the mobile phone have a Bluetooth connection. When the mobile phone is requested to make a call, the Bluetooth earphone 20 is used for answering, that is, the Bluetooth earphone 20 is taken out from the earphone position 11 so that the second terminal posts 22 of the Bluetooth earphone are powered off, and the Bluetooth earphone 20 is connected to the mobile phone, and at the same time, the mobile phone is controlled to answer the call. When the Bluetooth earphone 20 returns to the earphone position 11, the second terminal posts 22 are reconnected to the first terminal posts 13 to charge the Bluetooth earphone 20, and the Bluetooth earphone 20 controls the mobile phone 10 to hang up.

Specifically, the car charger 10 connected to the power outlet of the vehicle is disposed in the vehicle and can be used to charge the Bluetooth earphone 20. Specifically, the power output port may be a power port of a cigarette lighter, and the car charger 10 is provided with the earphone position 11 for placing the Bluetooth earphone 20. Because the earphone position 11 is provided with a first magnetic number 12 and two first terminal posts 13, and the Bluetooth earphone 20 is provided with a corresponding second magnetic number 21 and two second terminal posts 22, it is convenient for the driver to replace the Bluetooth earphone 20 back to the car charger 10 for charging, the driver no need to low head to observe and accurately find the earphone position 11, Since the first magnetic member 12 and the second magnetic member 21 attract each other, the Bluetooth earphone 20 can automatically return to the earphone position 10 by means of the magnetic attraction, The process does not affect the observation of an external environment, thereby improving the safety of the driver when driving the vehicle, and also avoiding falling caused by unstable connection of the Bluetooth earphone 20 when the vehicle runs. Then, the second terminal posts 22 are connected to the first terminal posts 13 so that the car charger 10 charges the Bluetooth earphone 20.

When the vehicle runs, the Bluetooth earphone 20 is charged in the car charger 10, the Bluetooth earphone 20 is kept in a power-on state and is automatically connected to the mobile phone through Bluetooth. When the mobile phone is requested to communicate, the Bluetooth earphone 20 is taken out, and at this time, the second terminal posts 22 are separated from the first terminal posts 13 and the second terminal posts 22 is powered off so that the Bluetooth earphone 20 is disconnected from the power supply of the vehicle and automatically answered the call. When the Bluetooth earphone 20 is put back into the earphone position 11, the second terminal posts 22 are connected to the first terminal posts 13 again, and the second terminal posts 22 receive a voltage input to recharge the Bluetooth earphone 20, and at this time, the Bluetooth earphone 20 hangs up the call. Preferably, the Bluetooth earphone 20 is provided with a touch switch only capable of adjusting the volume, which facilitates the driver to pick up the Bluetooth earphone 20 and direct use, and the driver does not need to worry about what switch is mistakenly touched by a finger to affect a call. Only one finger is required to touch the touch switch to adjust the volume, for example, double-clicking the touch switch to increase the volume, and triple-clicking the touch switch to decrease the volume so that it is not necessary to find a mobile phone to press a volume key, thereby improving driving safety. Further, the Bluetooth earphone 20 is a half-in-ear earphone and is provided with two microphones; the half-in-ear earphone does not affect the driver to hear the external environmental sound of the vehicle; and the two microphones enable the driver to still maintain a clear call effect in a high-speed driving or noisy environment.

Further, the Bluetooth earphone 20 and the car charger 10 are respectively equipped with a first sensing element and a second sensing element. When the first sensing element and the second sensing element are separated from sensing each other, and the input voltage of the second terminal posts 22 of the Bluetooth earphone 20 drops from 5V to 0V, the Bluetooth earphone 20 is connected to the mobile phone and connects the incoming call. When the first sensing element and the second sensing element mutually sense each other, and the Bluetooth earphone 20 detects voltage input from the second terminal posts 22, the mobile phone automatically hang up.

Specifically, when the vehicle runs, the Bluetooth earphone 20 is charged in the car charger 10, and the first sensing element of the Bluetooth earphone 20 and the second sensing element of the car charger 10 mutually senses, so that the Bluetooth earphone 20 is kept in a power-on state, and is always in a Bluetooth connection with the mobile phone. When a mobile phone is requested to make a call, the driver takes out the Bluetooth earphone 20 from the earphone position 11, the input voltage of the second terminal posts 22 of the Bluetooth earphone 20 drops from 5V to 0V, the first sensing element and the second sensing element are separated from sensing, the two are combined, and the Bluetooth earphone 20 automatically connects the incoming call.

When the driver finishes the call and puts the Bluetooth earphone 20 into the earphone position 11, the first sensing element of the Bluetooth earphone 20 and the second sensing element of the car charger 10 mutually sense each other, the Bluetooth earphone 20 detects that the voltage is input to the second terminal post 22 and rises from 0 to 5V, and the Bluetooth earphone 20 controls the mobile phone to hang up. Preferably, the first sensing element is a Hall sensor, and the second sensing element is a magnet. When the mobile phone is requested to make a call, the Bluetooth earphone 20 is taken out from the earphone position 11, the input voltage of the second terminal posts 22 of the Bluetooth earphone 20 is dropped from 5V to 0 and the Hall sensor cannot detect a magnetic field so that the Bluetooth earphone 20 is connected to the incoming call. When the Bluetooth earphone 20 is placed back in the earphone position 11, it is detected that the input voltage is on the second terminal posts 22, which rises from 0V to 5V, the Hall sensor detects the magnetic field again, and the Bluetooth earphone 20 controls the mobile phone to hang up.

Further, in the call process of the mobile phone, the Bluetooth earphone 20 is taken out from an earphone position 11, and the call of the mobile phone is switched to the Bluetooth earphone 20. Specifically, when the vehicle runs, the Bluetooth earphone 20 is kept on and always in a Bluetooth connection with the mobile phone. The driver directly uses the mobile phone to make a call. In this case, the Bluetooth earphone 20 is charged in the car charger 10 and does not seize the call permission of the mobile phone. In consideration of driving safety or privacy later, the driver takes out the Bluetooth earphone 20 from the earphone position 11, and the Bluetooth earphone 20 detects that the input voltage of the second terminal posts 22 is dropped from 5V to 0, and the Bluetooth earphone 20 may send a command to the mobile phone through the Bluetooth connection so that the mobile phone switches the call to the Bluetooth earphone 20.

Further, after the vehicle is started up, the supply power of the vehicle to the Bluetooth earphone 20 by means of the car charger 10, and the Bluetooth earphone 20 is activated to start up. After the vehicle is shut down, the vehicle is powered off, the voltage of the Bluetooth earphone 20 is 0, the Bluetooth earphone identifies that the input voltage of the second terminal posts 22 is 0, the first sensing element and the second sensing element keep mutual sense, and the Bluetooth earphone 20 is powered off.

Specifically, after the vehicle is started up, the power supply of the vehicle inputs the voltage to the Bluetooth earphone 20 through the car charger 10, and the Bluetooth earphone 20 is activated to start up. The Bluetooth earphone 20 detects that the voltage is input on the second terminal posts 22, and the first sensing element and the second sensing element mutually sense each other, causing the Bluetooth earphone 20 and the car charger 10 to keep in connecting. When the vehicle shuts down, the power supply is turned off, and the car charger 10 can not supply power. If the Bluetooth earphone 20 is placed in the earphone position 11, the Bluetooth earphone 20 detects that the output voltage of the second terminal post 22 drops to 0, the first sensing element and the second sensing element still mutually sense each other, the Bluetooth earphone automatically turned off. If the Bluetooth earphone 20 is not placed in the earphone position 11, the first sensing element and the second sensing element are separated from sensing, and the Bluetooth earphone 20 keeps calling, which provents the vehicle from shutting down, the Bluetooth earphone 20 is immediately turned off to hang up the phone, or it is misjudged that the Bluetooth earphone 20 picks up the earphone position 11 to connect the phone, thereby affecting the using experience of the driver.

The working principle of the vehicle-mounted earphone call method of the present disclosure is shown in the flowchart of FIG. 1, and the method includes:
Step 1, after the vehicle is started up, the car charger outputs 5V voltage to the Bluetooth earphone 20, the Bluetooth earphone 20 turns on. Specifically, after the vehicle is started up, the vehicle will output a 12 Voltage to the car charger 10, the car charger 10 is equipped with a Voltage reducing chip to drop the voltage from 12V to 5V, and then a 5V voltage is output to the Bluetooth earphone by means of the connection between the first terminal posts and the second terminal posts, and the 5V voltage can activate the Bluetooth earphone to power on. After the Bluetooth earphone is powered on, if the Bluetooth earphone is not paired with the mobile phone of the driver, the Bluetooth earphone enters a pairing mode first, and the driver performs manual pairing and Bluetooth connection. If the Bluetooth headset is paired with the mobile phone, the Bluetooth earphone is automatically connected to the mobile phone after being powered on.
Step 2, after the Bluetooth earphone 20 is successfully connected to the mobile phone, judging whether the mobile phone has an incoming call. If there is an incoming call or a call state, according to requirements, whether to use the Bluetooth earphone to call. If there is no incoming call, the Bluetooth earphone is kept in a power-on connection state. Specifically, after successfully connecting to a mobile phone, the Bluetooth earphone 20 maintains a power-on connection state. When the mobile phone receives an incoming call request, the driver takes the Bluetooth earphone out of the car charger; the Bluetooth earphone detects that the voltage drops from 5V to 0, and automatically connects the incoming call from the mobile phone by means of the Bluetooth, the voice received by the mobile phone is transmitted to the Bluetooth earphone via the Bluetooth for playing, and the Bluetooth earphone receives a voice response from the driver and transmits same to the mobile phone via the Bluetooth, completing a privacy call between the driver and the calling user.

When the mobile phone is in a communicating state, the Bluetooth earphone is in the car charger and detects the voltage stable, at this time, the Bluetooth earphone will not seize the call permission, and the driver can continue to call with the mobile phone. Only when the driver takes out the Bluetooth earphone from the car charger, the Bluetooth earphone sends an instruction to the mobile phone by means of Bluetooth, so that the mobile phone transfers the call permission to the Bluetooth earphone, thereby ensuring that the call comes out from the Bluetooth earphone or the mobile phone without additional manual adjustment. When the call is completed, the Bluetooth earphone is put into the car charger, and when the Bluetooth earphone detects that the voltage increases from 0 to 5V, the mobile phone automatically hangs up. The Bluetooth earphone always keeps a power-on connection state in the car charger.
Step 3, after the vehicle shuts down, the Bluetooth is automatically powered off. Specifically, after the vehicle is shut down, the vehicle is powered off, the car charger cannot supply power for the Bluetooth earphone, and the Bluetooth earphone detects that the voltage drops from 5V to 0 and is automatically powered off.

Preferably, the Bluetooth is equipped with a Hall sensor, and the car charger is equipped with a magnet. After the vehicle is started up, the car charger supplies a 5V voltage to the Bluetooth earphone and activates the Bluetooth earphone to start up. After the Bluetooth earphone is started up, it automatically connects to the paired mobile phone. The Bluetooth earphone always detects a voltage of 5V, and the Hall sensor detects a magnetic field so that the Bluetooth earphone keeps a state connected to the mobile phone.

When the mobile phone receives a call, the driver takes out the Bluetooth earphone from the car charger, the Bluetooth earphone detects that the voltage drops from 5V to 0, the Hall sensor cannot detect a magnetic field, and the Bluetooth earphone automatically connects to the call. After the call is finished, the driver puts the Bluetooth earphone back into the car charger; the Bluetooth earphone detects that the voltage rises from 0 to 5V; the Hall sensor detects a magnetic field and automatically hangs up the call.

When the driver makes a call using the car's Bluetooth or mobile phone, the Bluetooth earphone is inside the car charger and detects a voltage of 5V. The Hall sensor detects the magnetic field, and the Bluetooth earphone will not seize the call permission, ensuring that both the up and down calls come from the Bluetooth earphone or the mobile phone. If the driver picks up the Bluetooth earphone and the Bluetooth earphone detects a voltage dropping from 5V to 0, and the Hall sensor cannot detect the magnetic field, the Bluetooth earphone will send an instruction to the mobile phone through Bluetooth to switch the call to the Bluetooth earphone.

When the vehicle is turned off, the vehicle power is cut off, causing the car charger to supply a zero voltage for the Bluetooth earphone. The Bluetooth earphones detect a zero voltage, and the Hall sensor detects the magnetic field, causing the Bluetooth earphones to automatically shut down, which avoids turning off the Bluetooth earphones immediately or mistaking that the Bluetooth earphone is taken out for making a call after the vehicle is shut down. The voltage level and the presence or absence of the magnetic field of the Hall sensor are used in conjunction with detection, providing the driver with a better using experience.

The above are only the preferred embodiments of the present disclosure and are not intended to limit the present disclosure. Any modifications, equivalent substitutions, and improvements made within the spirit and principles of the present disclosure should be included within the scope of protection of the present disclosure.

1. A vehicle-mounted earphone call system, comprising a car charger and a Bluetooth earphone; said car charger is used for connecting a power outlet of a vehicle; an earphone position is provided in the car charger and used for placing said Bluetooth earphone; a first magnetic member and two first terminal posts are provided in said earphone position, and a second magnetic member and two second terminal posts are provided in said Bluetooth earphone; when said Bluetooth earphone is placed in said earphone position, said second magnetic member and said first magnetic member attract each other, and said two second terminal posts are connected to said two first terminal posts; said Bluetooth earphone and said mobile phone is in a Bluetooth connection; when said mobile phone is requested to make a call, said Bluetooth earphone is taken out from said earphone position so that said second terminal posts of said Bluetooth earphone are powered off, and at the same time, said mobile phone is controlled to answer said call; when said Bluetooth earphone returns to said earphone position, said second terminal posts are reconnected to said first terminal posts to charge said Bluetooth earphone, and said Bluetooth earphone controls said mobile phone to hang up.

2. The vehicle-mounted earphone call system according to claim 1, wherein said Bluetooth earphone and said car charger are respectively equipped with a first sensing element and a second sensing element; when said first sensing element and said second sensing element are separated from sensing each other, and an input voltage of said second terminal posts of said Bluetooth earphone drops from 5V to 0V, said Bluetooth earphone is connected to said mobile phone and connects said call; when said first sensing element and said second sensing element mutually sense each other, and said Bluetooth earphone detects said input voltage from said second terminal posts, said mobile phone automatically hangs up.

3. The vehicle-mounted earphone call system according to claim 2, wherein said first sensing element is a Hall sensor arranged in said Bluetooth earphone, said second sensing element is a magnet arranged in said earphone position, when said Bluetooth earphone is taken out from said earphone position, said Hall sensor can not detect said magnet field.

4. The vehicle-mounted earphone call system according to claim 1, wherein when said mobile phone calls, said Bluetooth earphone is taken out from said earphone position, and said call is switched to said Bluetooth earphone.

5. The vehicle-mounted earphone call system according to claim 2, wherein when said mobile phone calls, said Bluetooth earphone is taken out from said earphone position, and said call is switched to said Bluetooth earphone.

6. The vehicle-mounted earphone call system according to claim 3, wherein when said mobile phone calls, said Bluetooth earphone is taken out from said earphone position, and said call is switched to said Bluetooth earphone.

7. The vehicle-mounted earphone call system according to claim 2, wherein after said vehicle is started up, a supplies power of said vehicle charges said Bluetooth earphone by means of said car charger and actives said Bluetooth earphone to start up; when said vehicle is shut down, said supplies power of said vehicle is powered off, said input voltage of said Bluetooth earphone is zero, said Bluetooth earphone identifies said zero input Voltage, and said sensing element and said second sensing element keep mutual sense, and said Bluetooth earphone is powered off.

8. The vehicle-mounted earphone call system according to claim 2, wherein after said vehicle is started up, a supplies power of said vehicle charges said Bluetooth earphone by means of said car charger and actives said Bluetooth earphone to start up; when said vehicle is shut down, said supplies power of said vehicle is powered off, said input voltage of said Bluetooth earphone is zero, said Bluetooth earphone identifies said zero input Voltage, and said sensing element and said second sensing element keep mutual sense, and said Bluetooth earphone is powered off.

9. The vehicle-mounted earphone call system according to claim 1, wherein said Bluetooth earphone is equipped with a touch switch that can only adjust a volume.
